(19) United States
(12) Patent Application Publication
(10) Pub. No.: US 2009/0315294 A1
(43) Pub. Date: Dec. 24, 2009

(54) Vehicle

(76) Inventor: Giuseppe Conti, Impruneta (IT)

Correspondence Address: THE WEBB LAW FIRM, P.C., 700 KOPPERS BUILDING, 436 SEVENTH AVENUE, PITTSBURGH, PA, 15219, US

(21) Appl. No.: 12/375,294

(22) PCT Filed: Jul. 26, 2007
(86) PCT No.: PCT/IT07/00528

§ 371 Date: Jan. 27, 2009

(30) Foreign Application Priority Data
Jul. 28, 2006 (IT) PI 2006 A 000097

(51) Int. Cl. B62M 1/04

(52) U.S. Cl. 280/221

(57) ABSTRACT

A vehicle with two or more wheels including at least one or more surfaces on which it is possible to position one's feet and to exert an alternate force by pushing the heel or the point of the foot on said one or more surfaces; and motion transmission means connected to said one or more surfaces and to said one or more wheels of the vehicle itself.

The present invention relates to the technical field concerning the production of vehicles with two or more wheels. In particular, it relates to the technical field concerning the production of vehicles operated by the user's force without however using traditional pedals. In fact, the invention relates to a “step operated” vehicle. Pedal operated two-wheel vehicles, that is to say traditional bicycles, are well-known to everybody. Scooters are well-known, too. These means and other means are used to move from one place to the other and to do physical activity.

The aim of the present invention is to provide an alternative means which offers the advantage of allowing a correct body motion and of allowing the user to train himself/herself with agility by moving in the open air. Being the invention operated by means of a pedal-push system of an innovative step-operated type, this determines a correct and alternate “guided” body motion which offers a double advantage when using said means: a vehicle according to the invention can be used at the same time as a means of transport and as a gym equipment; furthermore, it isn't necessary an intense and/or tiresome effort to make said movement. Moreover, the vehicle has a reduced size and is easily positionable into the boot of any car.

The advantages offered by the present invention, thanks to the prerogatives of a motion feed system which foresees a “step-operated” pedal system, basically consist in combining the usefulness of a comfortable means of transport with an excellent gym equipment, while the mechanical conception of the forward motion device allows an excellent ratio between applied energy (force) and effective performance of the cycle in relation to the forward motion; said performance can be increased by inserting gears and by consequently acting on the ratios, without however modifying the basic concept of the forward motion device; the vehicle can be realised with three wheels and can easily be employed by users who do not have any special athletic or coordination qualities, although it guarantees an excellent stability; thanks to the presence of three wheels, it is suitable for people of any age and of any physical/aptitudinal predisposition and it provides the same usefulness of the movement and the physical benefits due to a specific movement; it can be provided with a transmission with advantageous ratios, suitable for use in hiring services, for walks in tourist routes an so on; if it realised with two wheels, it is included in a more sportive production line; it provides a more agile and less space-consuming means suitable for city centres with high traffic density.

These and other advantages and characteristics of the invention will be best understood by anyone skilled in the art from a reading of the following description in conjunction with the attached drawings given as a practical exemplification of the invention, but not to be considered in a limitative sense, wherein:

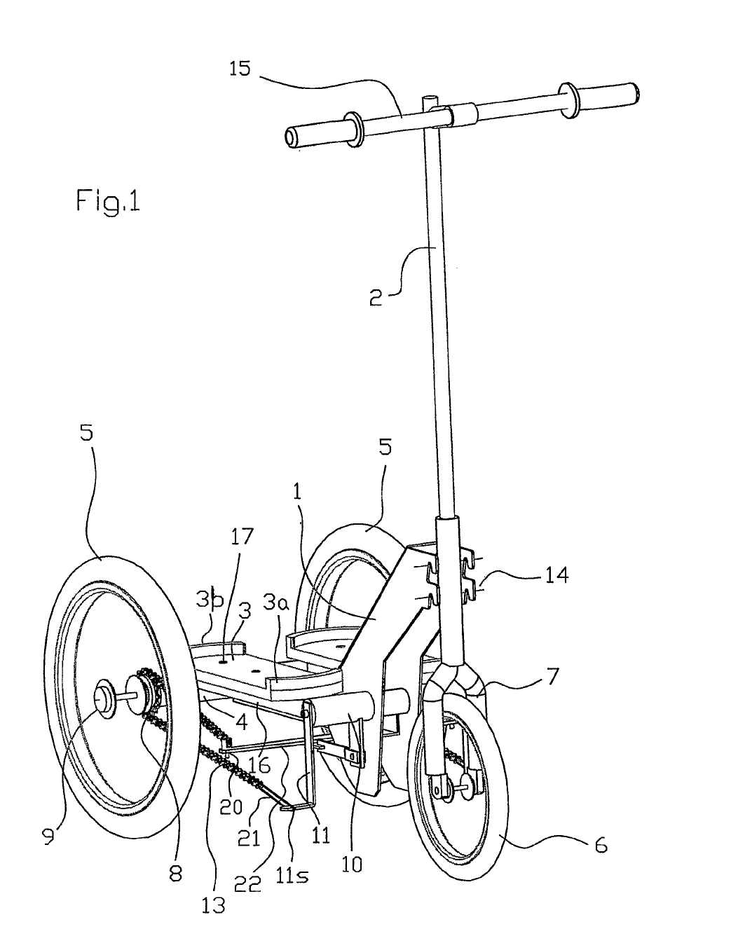

FIG. 1 shows a perspective schematic view with omitted parts of a possible embodiment of a three-wheel vehicle;

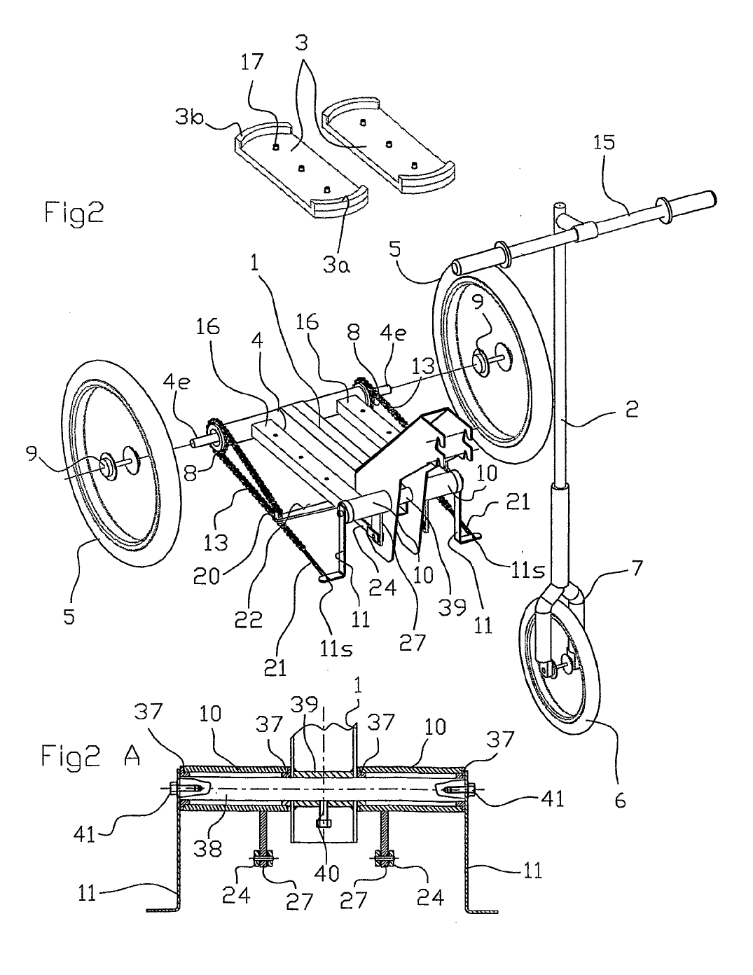

FIG. 2 shows an exploded view of the vehicle components of FIG. 1; FIG. 2A shows a cross sectional view of the assembly of the front rotation axis of the pedals;

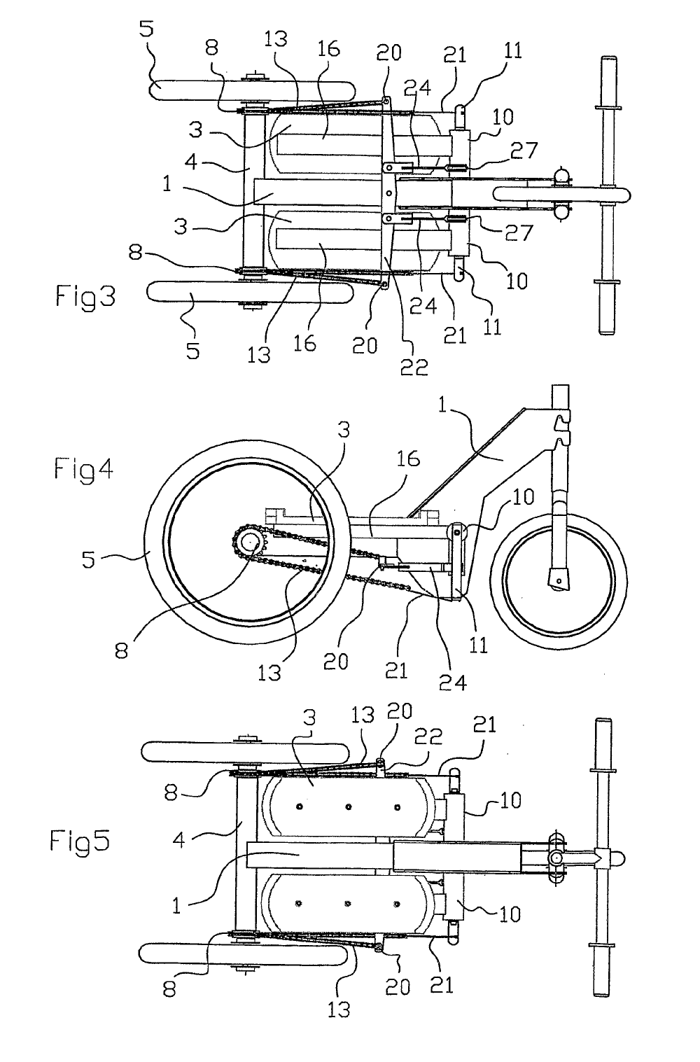

FIG. 3 shows a bottom plan view of the vehicle;

FIG. 4 shows a lateral view of the vehicle;

FIG. 5 shows a top plan view;

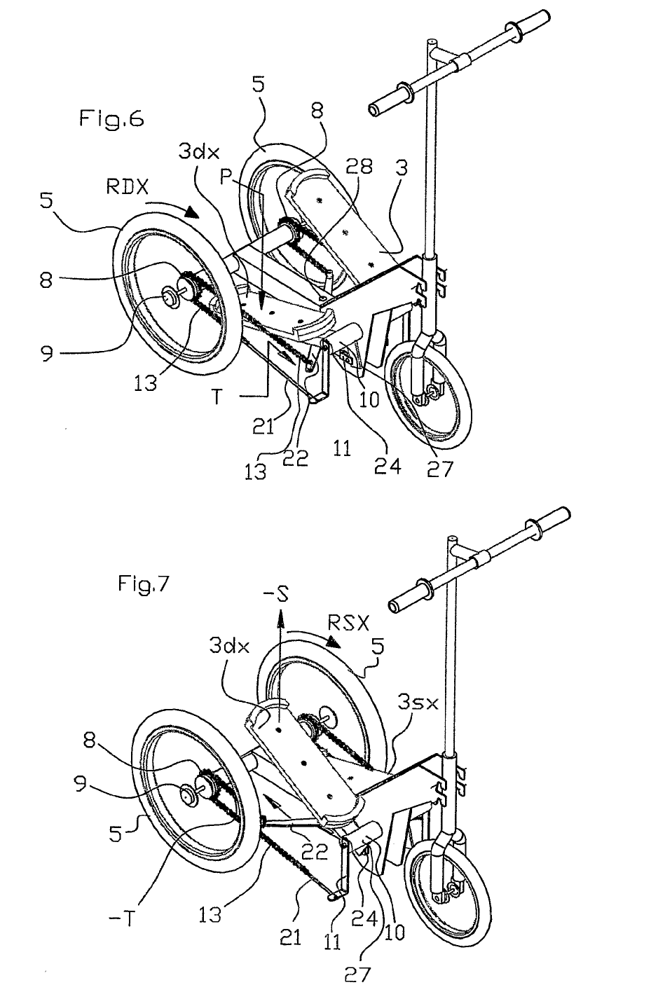

FIG. 6 is a perspective view in which the vehicle is shown during the compression phase of the right pedal;

FIG. 7 shows a subsequent dynamic phase with respect to FIG. 6, in which the lifting of the right pedal takes place;

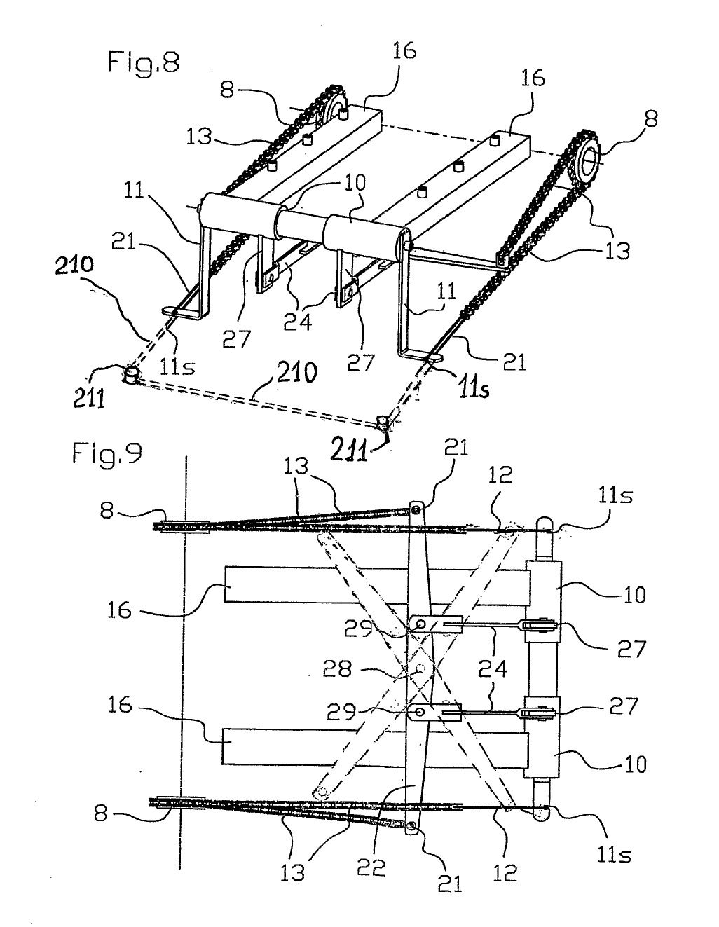

FIG. 8 is a schematic perspective view of the forward motion system extrapolated by the means;

FIG. 9 shows the same components as FIG. 8 in a plan view;

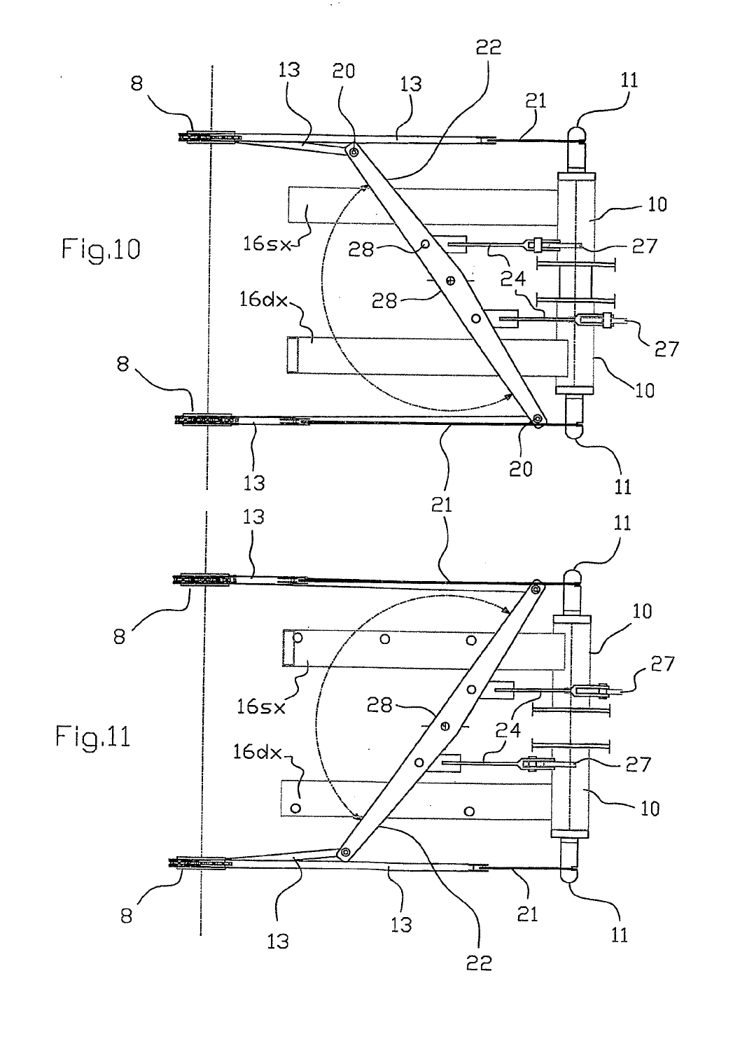

FIG. 10 is a view similar to FIG. 9 in which the vehicle is in the forward phase: in this case a compression force is exerted on the right pedal;

FIG. 11 shows the subsequent motion with respect to what is illustrated in FIG. 10, with a compression force on the left pedal;

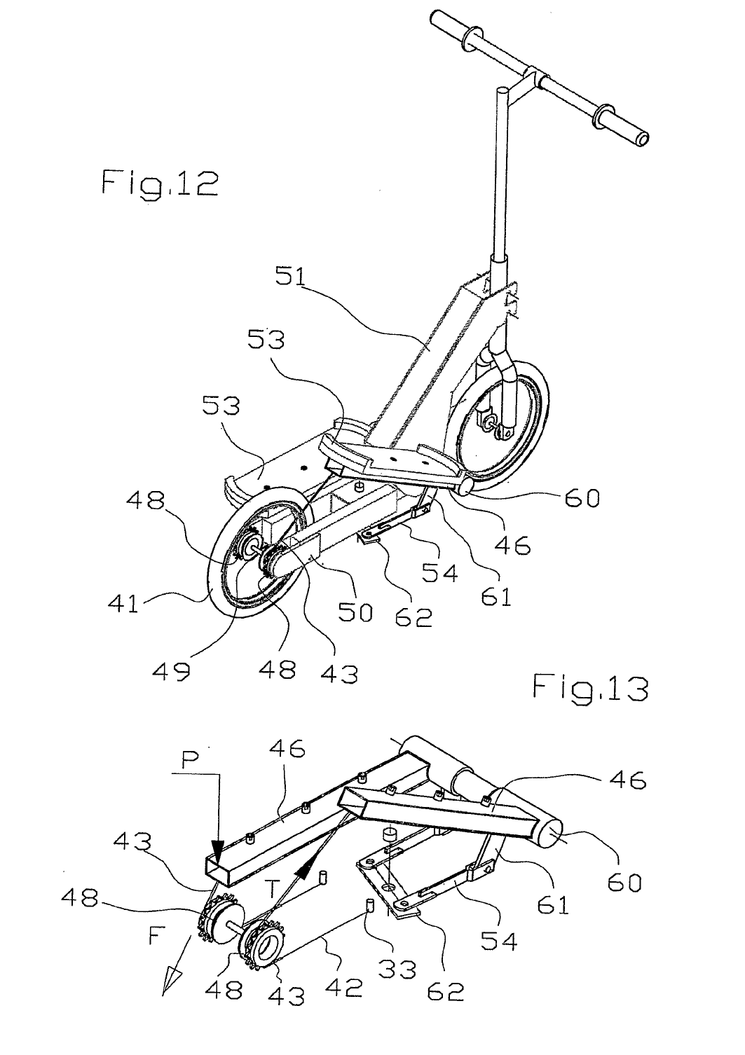

FIG. 12 shows another further embodiment of the invention, realised with two wheels instead of being realised with three wheels;

FIG. 13 shows a perspective view of the forward motion device.

The main components of the means are indicated with reference to the enclosed drawings. The base framework (1) consists of a metal box, realised with any well-known methods and technologies and features an angulated front part, at whose end the fork (7) of the front wheel (6) is supported. A common stud (2) of suitable size, for example of the telescopic type, so as to be adapted to the various heights required by the user, supports the handle (15) upperly. Thanks to the simple manual use of suitable well-known clamps (14) (not illustrated) of any constructive type, the disassembly of the whole front system which supports the wheel is rendered easy and immediate, without using special keys or other tools. The brake plant as well as the other accessories have not been illustrated, being said accessories of a well-known type and applicable to the means without any particular problems. Thanks to the limited speed of the vehicle, for example, the brake plant can consist of a disc brake or of a drum brake which acts on the front wheel and can be commanded by a conventional lever. As an alternative, it is possible to foresee braking organs acting on the tyre cover of one of the rear wheels. In practice said braking organs can comprise a pivoted lever which can be operated by one the user's foot and acts on the tyre thread of the tyre cover or The frame (1) consists of a horizontal part which ends in the back with a cross element (4) consisting in a round metal tube which is perpendicularly welded to the frame and has a length suitable for distancing the two rear wheels (5) so that they reach the most appropriate measure. Said size is a compromise between the need for reduced space consumption and the stability of the vehicle. The circular shape of the back cross element (4) facilitates the assembly of bushings, pads, suitably bored supports capable of supporting the axis to which they are keyed with excellent mechanical resistance features and respectively rubber wheels and free-wheel pinions.

Symmetrically, the pinions (8) are positioned adjacent to the ends of the cross element (4) and said pinions a are mounted on a “free wheel” bearing which allows their “solidal” rotation in one direction (by dragging the wheel into rotation in this case) and their “idle” rotation in the reverse direction by disengaging their rotation with respect to that of the hub (9) of the wheels (5). The same figure shows the two pedals (3) which feature a suitable raised edge both frontally (3a) and rearwardly (3b) so as to facilitate the stability of the user. The pedals (3) are fixed by means of screws (17) to a lower metallic support (16) which ends frontally with a circular bushing (10); the bushing (10) is capable of rotation on its longitudinal axis, as described in the following.

The vehicle comprise, on each side, a vertical metallic lever (11) provided with a lower-end edge turned outwards, on which a seat is provided (11s) for housing the elastic terminal (21) of a chain (13). The chain, engaged on the pinion (8), is fixed on a corresponding fixing element (20) mounted at the ends of a balancer (22).

FIG. 2 shows the body of the framework (1), the round rear bar (4) with turned ends (4e) necessary to support the pinions (8) and the hubs (9) of the rear wheels (5). Moreover, it also shows the components of the forward motion device consisting of pinions (8) around which the transmission chain (13) is engaged which, on the lower side, is connected to an elastic terminal (21) having a suitable consistency and development and which is anchored in traction to the seat (11s) of the lever (11), integral to the internal pinion, on which the lower support (16) of the pedal (3) rotates, adjacently to the axis of the lower bushing.

This figure, with respect to the previous figure, shows more clearly the reverse unwinding of the chain (13) which ends on a suitable fork or fixing point (20) stably positioned at the end of the balancer (22). Said balancer, more internally, is provided with a further hinge point on which a further connection lever (24) acts and “closes” the dynamic system through an end fork by connecting itself to a further element (27) welded on the rotary bushing (10) of the under-pedal or lower support (16).

FIG. 2A, instead, is a cross sectional view of the assembly of the front rotation axis of the pedals: the front part of the frame (1) is internally reinforced by means of a bushing (39) which is welded and then bored and inside which the rotation axis (38) is seated, being said axis fixed and integral to the structure by means of a screw or a grab screw (40). The lateral, symmetric jutting out of the two sides is sufficient to contain the devices keyed on it. Said devices consists of front bushings (10) of the under-pedals (16); at their ends, the bushings are provided with two Teflon or brass (or in any anti-friction material) bushes (37). This remarkably reduces friction with respect to a coupling carried out along the whole bushing (10) with a great advantage in the rotation. Moreover, the bush (37) functions as a dynamic support on the frame and prevents the bushing (10) to come into direct contact with the frame.

Externally, instead, the fixed axis (38) is slightly longer than the system keyed on it, so as to allow the external fixing of the levers (11) without dragging them into rotation by friction by the rotating dynamics of the system. The lever (11) is blocked at its head by a suitable screw (41). The figure also shows a sectional view of the vertical plate (27) vertically welded on the bushing (10) and the fork (24) which connects the bushing (10) to the balancer (22).

FIG. 3 shows a plan view from the lower side in the middle. The figure shows the single elements. One of them is the balancer (22) which is centrally hinged on the frame (1). Laterally, on the same inter-axis with respect to the longitudinal axis, fork levers (24) are hingedly fixed on the balancer and end with a fork on the plate (27) welded to the bushing (10) of the under-pedal (16). The end lever (11), on which the elastic sector (21) allowing the connection to the transmission chain (13) is anchored, is mounted at the end of the bushing (10); said chain (13), in its development, winds itself around the pinion (8) by turning around it and ends at the end of the balancer (22), to which it is integral by means of the fork bushing (20).

FIG. 4 shows a lateral view of the vehicle with the pedals (3) in an intermediate position. This view shows the cycle which is planned so that its mobile mechanics (various levers, chain and various mobile parts) are disposed lowerly, underneath the position of the feet on the pedals, so as to avoid any risks of contact with the parts in motion. During its motion, the cycle can obviously be provided with suitable carters which are in compliance with the security standards and contribute to the aesthetics of the means.

FIG. 5 shows a top plan view of the vehicle. It illustrates the rotary bushings (10) frontly, at the ends of which the support terminals (11) of the elastic rope (21) are mounted.

FIG. 6 shows the compression phase (P) of the right pedal (3dx): said action consists of the anticlockwise rotation of the corresponding bushing (10) and of the consequent forward motion of the plate (27) which is upperly welded to the bushing; said forward motion is transmitted to the balancer (22) by means of a fork (24) having a stable junction point on both parts. The forward motion of the balancer causes a front traction (T) of the chain (13) which rotates the pinion (8) which is integral to the hub (9) of the wheel (5) so as to determine its forward motion (RDX). The different development of the chain in this position is compensated by the lengthening of the elastic rope (21) which is anchored to the fixed support (11) on one end and stretches so as to allow the necessary run and to cover the development increase.

FIG. 7 shows the subsequent phase, in which the raising of the right pedal (3dx) takes place thanks to the reverse rotation of the balancer (22) which, through the fork, transmits a rotation in the clockwise direction to the bushing (10) integral to the under-pedal (16) and consequently integral to the pedal. In this case, the chain (13) will have a direction opposite to the previous one (−T) and, if recalled by the elastic rope (21) it will cause the pinion to rotate in the direction of its “idle rotation”, but it will not act on the wheel as it is not engaged due to the free wheel system so as to render the hub disengaged and free (9) of the wheel (5). The coupling pinion (8)/hub (9) can however be carried out with any type of mechanically well-know assembly, which, anyway, corresponds to the two different dynamics reactions in the reverse rotations.

FIG. 8 shows a perspective view of the forward motion system: in particular, it clearly shows the under-pedals (16) which are part of the same mechanical device which comprises the front bushings (10) and the vertical plates (27) welded to it; the fork (24) acts on said plates (27) and its aim is to transmit the motion of the pedals and of the under-pedals (16) to the balancer (22) which commands the traction and/or the non incident return of the chain (13), which is wound around the pinions (8) and which ends on the fixed levers (11) by means of the elastic rope (21). Alternatively to the solution described above, the two elastic ropes (21) can be joined each other by a portion (210), which passes around relevant elements (211), as represented by a discontinuous line in FIG. 8. In practice, with such solution, it is possible to utilize at the best the elastic reaction which is furnished not only by the two ropes (21) above described, but also by all the whole comprising the two ropes (21) and the connecting portion (210); advantageously said whole can be formed by only one elastic element or rope.

FIG. 9 shows the components of FIG. 8 in a plan view, from the lower side. The position shown is that with parallel pedals (3), with the under-pedals (16) on the same horizontal plane. Under these conditions, the forks (24) are equally aligned and fixed on the balancer by means of hinge pinions (29). The balancer (22), centrally hinged in (28), is substantially parallel to the axis of the wheels and perpendicular to the longitudinal axis of the vehicle.

FIG. 10 shows the device during the forward motion phase: in this case pressure has been exerted on the right pedal (16dx); the direct consequence of this is the forward motion of the right plate (27) by rotation of the bushing (10); said forward motion causes the fork (24) in traction to recall the balancer (22) which, by rotating around the hinge point (28) causes the complementary bushing to rotate in the reverse direction, so as to determine the raising of the left pedal (16sx). The right forward motion frontly recalls the chain (13) which is joined to the balancer in point (20); said motion of the chain involves the pinion (8) which, integral to the hub, rotates in this direction and allows the forward motion of the means, while, on the opposite side, the reverse rotation of the pinion generated by the reverse sliding of the chain (13) on it, does not affect the wheel, being the pinion mounted on a common commercial “free wheel” as described above.

The subsequent FIG. 11 shows the subsequent compression motion of the opposite pedal (under-pedal) (16sx) which activates exact specular dynamics, so as to obtain a continuous and elastic forward motion, easy to control and, relatively speaking, not particularly tiresome.

FIG. 12 shows a different embodiment of the invention which is realised with two wheels instead of with three wheels. The vehicle is supported by a frame (51) which is analogous to the previous means but provided with a rear fork (40) inside which the rear wheel is positioned. The free wheel pinions (48) are disposed on the hub (49) of said wheel, in symmetry and they are engaged by the transmission chain (43) as in the previous case; said chain, in this case, originates from the rear part of the pedal support (46) and, on the opposite end, it is provided with an identical elastic rope having the double function of tightener and of development recovery given by its variation in relation to the arc described by the rear part of the pedal. Even in this case, the elastic end is joined to a fixed point of the vehicle, to two suitable pins (33) positioned underneath the frame (51). Like in the three-wheel device, the pedals are fixed on two metallic supports (46) which end frontly with an identical bushing (60) provided lowerly with an integral plate (61) which develops vertically. Suitable forks (54) connect the motion to a balancer (62) with a limited width, so that they do not transversely exceed the overall dimensions of the vehicle. The balancer (62), in this case, controls the alternate motion of the right and left pedal (53). The traction (T) of the chain on the pinion (8) takes place by means of the vertical motion of the pedal which is commanded by the reverse compression motion. On the opposite side, the forward motion is obtained by the compressive action (P) of the weight of the user on the pedal which determines the reverse raising and causes an upward traction of the chain (43) which winds around the pinion (48) with a sufficient angle and causes it to rotate integral to the idle hub (49) on the opposite side due to the free wheel effect as previously explained.

The subsequent FIG. 13 shows the corresponding forward motion device and enhances some details for clearness reasons.

The invention can consist of a frame in a tubular metallic material derived from available semi-finished products or from an iron sheet which has been bent, welded, treated and painted. However, like for common bicycles, the frame can be realised in various metallic e non-metallic materials (aluminium, carbon fibers, plastic materials or any material having sufficient mechanical features).

As regards the features of the vehicle, a perfectly symmetrical anchorage of the various components on both sides is very important: as a consequence of this, the balancer dynamically connects the two pedals and causes their alternate motion which is due to the angular oscillation of the balancer which, commanded by the “thrust on the pedal” alternately lifts and lowers the rear part of the pedals which are hinged frontly.

Said dynamics cause the oscillation of the balancer which causes the traction of the chain over a distance given by the arc described by the thrust on the pedal and transmit the motion to the pinion (“engaged” in this direction) which, being solidal to the wheel, determines its rotation.

Being the two pedals connected by means of a balancer, a traction of the chain on the one side corresponds to an exactly reverse motion on the opposite side which is advantageously made “idle” (so that it does not affect the wheel) by the suitable assembly of the free wheel on which the pinions are keyed. So, through the alternate motion of the pedals and by carrying out a simple “step” motion and facilitated by the weight of the body itself, two rear wheels are alternatively brought into rotation, so as to simultaneously render the action of the chain on the “guided” wheel “idle” in order to obtain an agile and particularly light motion of the means thanks to the levering force of the pedal, with all the advantages offered by this solution.

In a further development, the invention may foresee a transmission gear by means of an assembled couple of pinions, so as to carry out a variation in the transmission ratios so as to allow an easier and lighter use of the force or, on the contrary, an increased development of the thrust on the pedal.

In practice, the two-wheel cycle typology reflects the same functional concept, except obvious structural modifications which do not affect either the function principle or the mechanical and use advantages that the forward motion device offers.

The various ratios may advantageously be varied so as to render the use of the vehicle more agile or more demanding when using it for walks or for training. The vehicle can advantageously be completed with protection parts (carters) which isolate the parts in motion from the zones physically occupied by the user, without particularly encumbering the overall size and the weight and improve the aesthetics of the means.

In practice, the execution details may equally vary as regards the shape, the size, the disposition of the elements, kind of materials used, within the solution idea that has been adopted and within the limits of the protection offered by the present patent.

1-15. (canceled)

16. A vehicle with two or more wheels comprising:
at least one or more surfaces on which it is possible to position one's feet and to exert an alternate force by pushing the heel or the point of the foot on said one or more surfaces; and
motion transmission means connected to said one or more surfaces and to said one or more wheels of the vehicle itself.

17. The vehicle of claim 16, wherein said surfaces feature an elongated shape so as to allow the positioning of the whole foot sole.

18. The vehicle of claim 17, wherein said surface is provided with an edge at its opposite ends.

19. The vehicle of claim 18, wherein said surfaces are fixed on a support for a pedal integral to the transmission means of the motion, so that by oscillating said surfaces it is possible to obtain the rotation of said one or more wheels.

20. The vehicle of claim 19, wherein said motion transmission means comprises one or more shaped surfaces and at least one balancer connected to said surfaces and disposed so that, through its alternate angular oscillation determined by the force exerted by the feet on the surfaces, it creates the motion of said one or more wheels by means of a transmission chain.

21. The vehicle of claim 20, wherein each of said one or more surfaces are connected to the balancer by means of a corresponding under-footboard or support provided with a corresponding bushing at one end, each provided with a vertical flat element on which a fork is hinged which, in turn, is hinged on the balancer to create the traction and/or the release of said chain.

22. The vehicle of claim 21, wherein said bushing consists of a cylinder which is free to rotate around a fixed cylinder by means of bushes.

23. The vehicle of claim 22, wherein two vertical levers are fixed at ends of the fixed cylinder, each of which ends with a horizontal part on which is fixed an elastic rope connected to the chain.

24. The vehicle of claim 23, wherein the balancer is connected at its ends to one end of the chain engaged on the pinions of said one or more wheels and ending on the opposite side, by means of an interposed elastic rope on said levers which are integral to the ends of the bushing.

25. The vehicle of claim 23, farther comprising two chains connected to each other by means of one or more portions of elastic rope.

26. The vehicle of claim 16, further comprising two transmission chains which are connected to the ends of the balancer by means of a suitable fixing element and engage the pinions with a suitable and sufficient angle, ending their development on suitable fixed points with an end junction in elastic rope which recovers the difference in the development of the transmission occurring during the alternate dynamics.

27. The vehicle of claim 16, farther comprising a pinion mounted on a free wheel so that it is integral to the corresponding hub of the wheel during the forward thrust, and wherein it is idle during the reverse rotation.

28. The vehicle of claim 16, further comprising three wheels.

29. The vehicle of claim 16, further comprising one front wheel and one rear wheel, and a framework provided with a rear fork inside which the rear wheel is positioned; and wherein, on the hub of said rear wheel, symmetrically, free wheel pinions are externally disposed and engaged by the transmission chain.

30. The vehicle of claim 29, wherein the transmission chain originates in the rear part of an under-pedal or support for pedal and, on the opposite end, it is connected to an elastic rope which has the double function of tightener and of recovery.
